(19) United States
(12) Patent Application Publication
(10) Pub. No.: US 2007/0038448 A1
(43) Pub. Date: Feb. 15, 2007

(54) Objection detection by robot using sound localization and sound based object classification bayesian network

(76) Inventor: Rini Sherony, Ann Arbor, MI (US)

Correspondence Address: GIFFORD, KRASS, GROH, SPRINKLE,;ANDERSON & CITKOWSKI, P.C., P.O. BOX 7021, TROY, MI, 48007-7021, US

(21) Appl. No.: 11/202,531

(22) Filed: Aug. 12, 2005

(51) Int. Cl. G10L 15/00

(52) U.S. Cl. 704/240

(57) ABSTRACT

An object detection system includes at least one sound receiving element, a processing unit, a storage element and a sound database. The sound receiving element receives sound waves emitted from an object. The sound receiving element transforms the sound waves into a signal. The processing unit receives the signal from the sound receiving unit. The sound database is stored in the storage element. The sound database includes a plurality of sound types and a plurality of attributes associated with each sound type. Each attribute has a predefined value. Each sound type is associated with each attribute in accordance with Bayesian's rule, such that a conditional probability of each sound type is defined for an occurrence of each attribute.

### BACKGROUND OF THE INVENTION

1. Field of the Invention

The invention relates to an object detection system for use with robots, and more particularly, to an object detection system utilizing sound localization and a Bayesian network to classify type and source of sound.

2. Description of the Related Art

It is a continuing challenge to design a mobile robot that can autonomously navigate through an environment with fixed or moving obstacles or objects along its path. The challenge increases dramatically when objects, such as a rolling ball, a moving vehicle and the like, are moving along a collision course with the robot. It is known to provide robots with visual systems that allow the robot to identify and navigate around visible objects. But, such systems are not effective in identifying moving objects, particularly where the objects are beyond the field of view of the visual system.

It remains desirable to provide an object detection system that allows a mobile robot to identify and navigate around a moving object.

### SUMMARY OF THE INVENTION

According to one aspect of the invention, an object detection system is provided for use with a robot. The object detection system comprises at least one sound receiving element, a processing unit, a storage element and a sound database. The sound receiving element receives sound waves emitted from an object. The sound receiving element transforms the sound waves into a signal. The processing unit receives the signal from the sound receiving unit. The sound database is stored in the storage element. The sound database includes a plurality of sound types and a plurality of attributes associated with each sound type. Each attribute has a predefined value. Each sound type is associated with each attribute in accordance with Bayesian's rule, such that a conditional probability of each sound type is defined for an occurrence of each attribute.

According to another aspect of the invention, a method of identifying objects is provided, which uses sound emitted by the objects. The method includes the steps of: providing a sound database which includes a plurality of sound types and a plurality of attributes associated with each sound type, wherein each attribute has a predefined value, and wherein each sound type is associated with each attribute in accordance with Bayesian's rule, such that a conditional probability of each sound type is defined for an occurrence of each attribute; forming a sound input based on sound emitted from the object; applying a filter to the sound input to facilitate extraction of spectral attributes that correspond with the attributes of the sound database; extracting the spectral attributes; comparing the spectral attributes of the sound input with the predetermined attributes of the sound database; and selecting the sound type has attributes with the highest similarity to the spectral attributes of the sound input.

According to another aspect of the invention, a method of training a Bayesian network classifier is provided. The method includes the steps of: providing the network with a plurality of sound types; providing the network with a plurality of attributes, wherein each attribute has a predefined value; defining a conditional probability for each attribute given an occurrence of each sound type; and classifying the sound types in accordance with Bayesian's rule, such that the probability of each sound type given a particular instance of an attribute is defined.

According to another embodiment of the invention, the plurality of attributes for each sound type is selected from the group consisting of: histogram features, linear predictive coding, cepstral coefficients, short-time Fourier transform, timbre, zero-crossing rate, short-time energy, root-mean-square energy, high/low feature value ratio, spectrum centroid, spectrum spread and spectral rolloff frequency.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is schematic of a robotic system incorporating an object detection system in accordance with one embodiment of the invention;

FIG. 2 is a schematic illustrating a method of detecting an object, according to an embodiment of the invention;

FIG. 3 is a schematic of a learning network classifier, according to another embodiment of the invention; and

FIG. 4 is a schematic of a sound localizing process, according to another embodiment of the invention.

### DETAILED DESCRIPTION OF THE INVENTION

The present invention provides an object detection system for robots. The inventive object detection system receives and processes a sound emitted from an object. The system determines what the object is by analyzing the sound emitted from the object against a sound database using a Bayesian network.

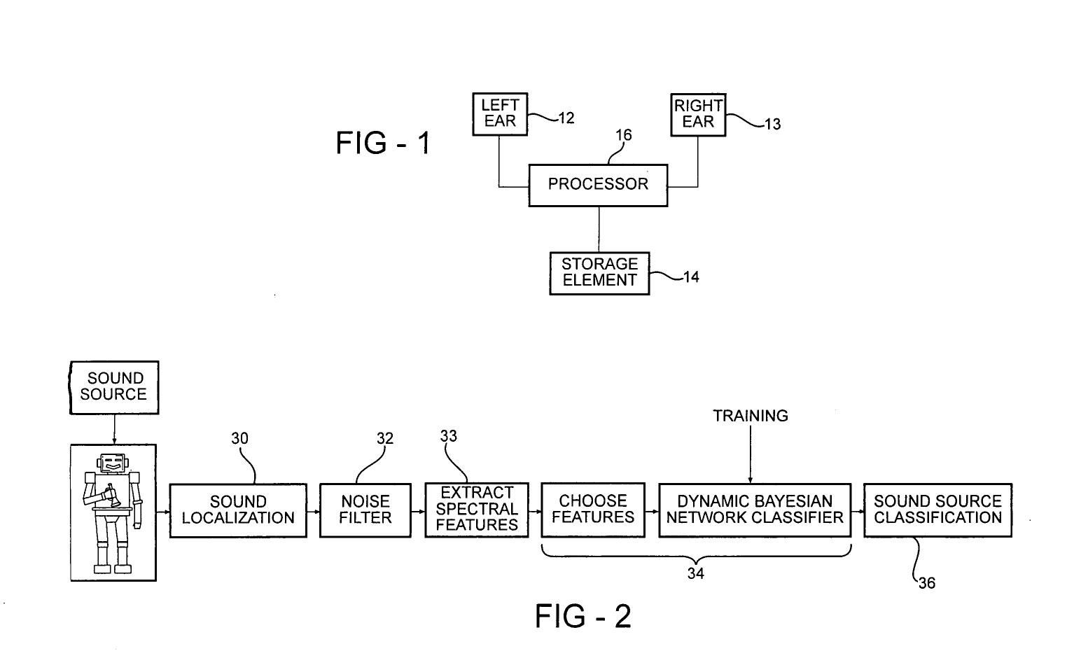

Referring to the FIG. 1, the object detection system includes a plurality of hardware components that includes left and right sound receiving devices 12, 13, a storage element 14, a processing unit 16. The hardware components can be of any conventional type known by those having ordinary skill in the art. The processing unit 16 is coupled to both the sound receiving device 12, 13 and the storage element 14. The system also includes an operating system resident on the storage element 14 for controlling the overall operation of the system and/or robot. Described in greater detail below, the system also includes software code defining an object detection application resident on the storage element 14 for execution by the processing unit 16.

The object detection application defines a process for detecting an object utilizing sound that is emitted from the object. Sound emitted “from the object” means any sound emitted by the object itself or due to contact between the object and another object, such as a floor. Referring to FIG. 2, the process includes the steps of localizing 30 the sound; applying 32 a filter to remove extraneous noise components and extract 33 a predetermined set of spectral features that correspond with a plurality of characateristics or attributes 22 defined in a sound database or network; comparing 34 the spectral features with respective attributes 22 stored on the network; identifying 36 a sound type in the network having attributes most like the spectral features of the sound; and classifying the sound as being of the sound type having attributes most like the spectral features of the sound emitted from the object.

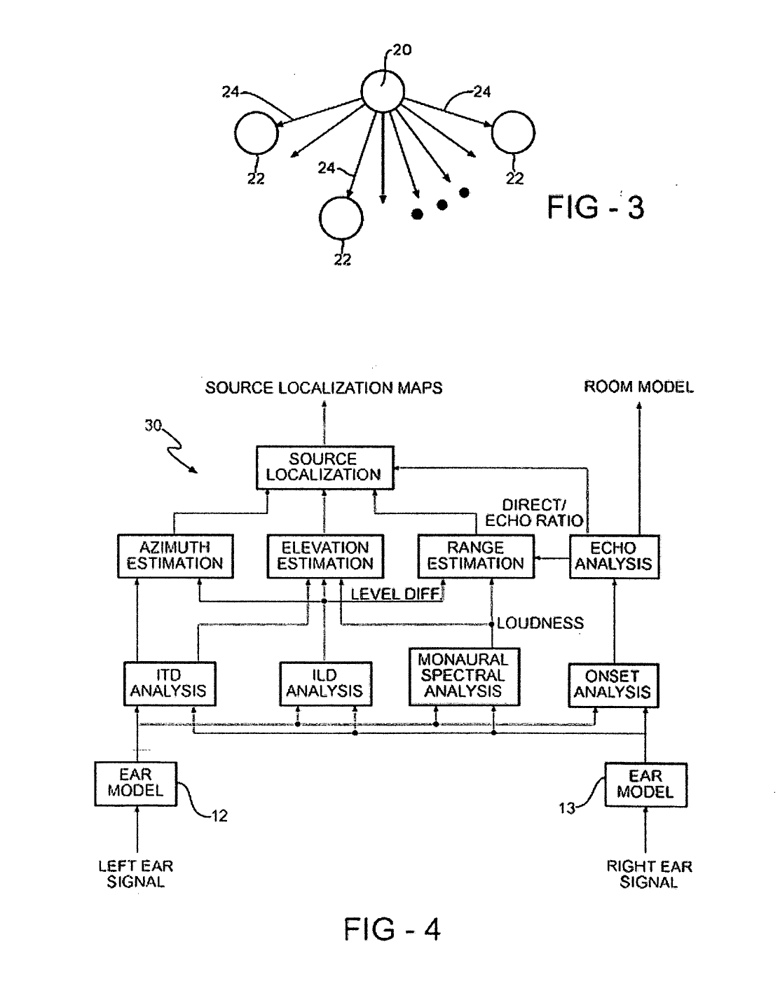

Referring to FIG. 3, the network is provided in the form of a Bayesian network stored in the storage element 14. Bayesian networks are complex algorithms that organize the body of knowledge in any given area by mapping out cause-and-effect relationships among key variables and encoding them with numbers that represent the extent to which one variable is likely to affect another. The network includes a plurality of nodes 20, 22. Arcs 24 extend between the nodes 20, 22. Each arc 24 represents a probabilistic relationship, wherein the conditional independence and dependence assumptions defined between the nodes 20, 22. Each arc 24 points in the direction from a cause or parent 20 to a consequence or child 22.

More specifically, each sound class or type 20 is stored in the network as a parent node. Associated with each sound type is the plurality of attributes 22 stored as a child node. Illustratively, the plurality of attributes 22 includes histogram features (width, symmetry, skewness), linear predictive coding (LPC), cepstral coefficients, short-time Fourier transform, timbre, zero-crossing rate, short-time energy, root-mean-square energy, high/low feature value ratio, spectrum centroid, spectrum spread, and spectral rolloff frequency. It should be appreciated that other attributes could be used to classify and identify the sound types.

In an embodiment of the invention, a method is provided for training the network. Prior to use in an application, the network is pre-trained from data defining the conditional probability of each attribute 22 given the occurrence of each sound type 20. The sound types 20 are then classified by applying Bayesian's rule to compute the probability of each sound type 20 given a particular instance of an attribute 22. The class of sound types having the highest posterior probability is established. It is assumed that the attributes 22 are conditionally independent given the value of the sound type 20. Conditional independence means probabilistic independence, e.g. A is independent of B given C, where Pᵣ(A/B, C)=Pᵣ(A/C) for all possible values of A, B, and C, where Pᵣ(C)>0.

Referring to FIG. 4, the sound localizing step is generally indicated at 30. The sound localizing step 30 includes the following steps.

A Fourier transform of the sound signal is computed. The relative amplitudes between the left 12 and right 13 receiving devices are compared to discriminate general direction of each frequency band. Frequencies coming from the same direction are clustered. The interaural time difference (ITD) is determined. The ITD is the difference between the arrival times of each signal in each ear. The interaural level difference (ILD) is determined. The ILD is the difference in intensity of each signal in each ear. A monaural spectral analysis is conducted, in which each channel is analyzed independently to achieve greater low elevation accuracy. The ITD and ILD results are combined to estimate azimuth. Elevation is estimated by combining ILD and monaural results. Optionally, ITD data is included in the elevation estimation for increased accuracy in the calculation.

The range or distance between the sound receiving devices 12, 13 and the object is estimated. The estimation of range considers one or a combination of factors, such as absolute loudness, wherein range is determined from signal drop off; excess level differences, wherein distance is derived from the difference in levels between multiple sound receivers; and the ratio of direct to echo energy based on signal intensities.

Onset data is collected, wherein the start of any new signals are identified. In this step, amplitude and frequency are analyzed to prevent false detection. Onset data is then used in an echo analysis, wherein the data serves as a basis for forming a theoretical model of the acoustic environment.

Finally, the analysis data collected above from the azimuth estimation, elevation estimation, range estimation and echo analysis are combined. The combined figures are used in an accumulation method, wherein a weighted average of the estimates from each method is calculated and a single, high-accuracy position for each sound source is outputted.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. An object detection system for use with a robot, said object detection system comprising:
at least one sound receiving element for receiving sound waves emitted from an object, said at least one sound receiving element transforming said sound waves into a signal;
a processing unit for receiving said signal from said sound receiving unit;
a storage element; and
a sound database stored in said storage element, said sound database includes a plurality of sound types and a plurality of attributes associated with each sound type, each attribute having a predefined value, each sound type being associated with each attribute in accordance with Bayesian's rule, such that a conditional probability of each sound type is defined for an occurrence of each attribute.

2. The object detection system as set forth in claim 1, wherein said sound types are arranged as parental nodes within said Bayesian network.

3. The object detection system as set forth in claim 2, wherein said attributes are arranged as child nodes with respect to said parental nodes within said Bayesian network.

4. The object detection system as set forth in claim 1, wherein said attributes are selected from the group consisting of: histogram features, linear predictive coding, cepstral coefficients, short-time Fourier transform, timbre, zero-crossing rate, short-time energy, root-mean-square energy, high/low feature value ratio, spectrum centroid, spectrum spread and spectral rolloff frequency.

5. A method of identifying objects using sound emitted by the objects, the method comprising the steps of:
providing a sound database which includes a plurality of sound types and a plurality of attributes associated with each sound type, wherein each attribute has a predefined value, and wherein each sound type is associated with each attribute in accordance with Bayesian's rule, such that a conditional probability of each sound type is defined for an occurrence of each attribute;
forming a sound input based on sound emitted from the object;
applying a filter to the sound input to facilitate extraction of spectral attributes that correspond with the attributes of the sound database;
extracting the spectral attributes;
comparing the spectral attributes of the sound input with the predetermined attributes of the sound database; and
selecting the sound type having attributes with the highest similarity to the spectral attributes of the sound input.

6. The method as set forth in claim 5, wherein the plurality of attributes for each sound type is selected from the group consisting of: histogram features, linear predictive coding, cepstral coefficients, short-time Fourier transform, timbre, zero-crossing rate, short-time energy, root-mean-square energy, high/low feature value ratio, spectrum centroid, spectrum spread and spectral rolloff frequency.

7. The method as set forth in claim 5, wherein the step of localizing the sound input includes computation of a Fourier transform based on the sound input.

8. The method as set forth in claim 5, wherein the step of localizing the sound input includes determining a directional component at each frequency band of the sound input.

9. The method as set forth in claim 5, wherein the step of localizing the sound input includes a clustering frequencies having substantially the same directional component.

10. The method as set forth in claim 5, wherein the step of localizing the sound input includes forming a pair of sound signals based on the sound emitted from the object.

11. The method as set forth in claim 10, wherein the step of localizing the sound input includes measuring a period of time elapsed between the formations of the sound signals to define an interaural time difference.

12. The method as set forth in claim 11, wherein the step of localizing the sound input includes measuring and determining a difference in amplitude between the sound signals to define an interaural level difference.

13. The method as set forth in claim 12, wherein the step of localizing the sound input includes estimating azimuth based on a combination of the interaural time and level differences.

14. A method of training a Bayesian network classifier, said method comprising the steps of:
providing the network with a plurality of sound types;
providing the network with a plurality of attributes, wherein each attribute has a predefined value;
defining a conditional probability for each attribute given an occurrence of each sound type; and
classifying the sound types in accordance with Bayesian's rule, such that the probability of each sound type given a particular instance of an attribute is defined.

15. The method as set forth in claim 14, wherein the plurality of attributes for each sound type is selected from the group consisting of: histogram features, linear predictive coding, cepstral coefficients, short-time Fourier transform, timbre, zero-crossing rate, short-time energy, root-mean-square energy, high/low feature value ratio, spectrum centroid, spectrum spread and spectral rolloff frequency.
